(19) United States
(12) Patent Application Publication
(10) Pub. No.: US 2026/0291061 A1
(43) Pub. Date: Sep. 24, 2026

(54) Balanced Input Planar-Printed Antenna Arrays as Coupled Wideband Modular Packages

(71) Applicant: The Government of the United States of America, as represented by the Secretary of the Navy, Arlington, VA (US)

(72) Inventor: Rick Kindt, Washington, DC (US)

(73) Assignee: The Government of the United States of America, as represented by the Secretary of the Navy, Arlington, VA (US)

(21) Appl. No.: 19/574,744

(22) Filed: Mar. 23, 2026

Related U.S. Application Data
(60) Provisional application No. 63/775,577, filed on Mar. 21, 2025.

(51) Int. Cl. H01Q 1/52; H01Q 1/50; H01Q 9/04

(52) U.S. Cl. CPC H01Q 1/523; H01Q 1/50; H01Q 1/526; H01Q 9/0407

(57) ABSTRACT

Systems and methods are provided for planar-printed antenna arrays that have balanced inputs (e.g., excitation pairs) that can directly mate with differential outputs on system electronics. The apertures can be produced with solder/signal pads in lieu of commercial connectors for pick-and-place, no touch labor integration of antenna apertures with panel electronics using Ball Grid Array (BGA) technology.

### CROSS REFERENCE TO RELATED APPLICATIONS

This application claims the benefit of U.S. Provisional Patent Application Number 63/775,577, filed on Mar. 21, 2025, which is incorporated by reference herein in its entirety.

### FEDERALLY SPONSORED RESEARCH AND DEVELOPMENT

The United States Government has ownership rights in this invention. Licensing inquiries may be directed to Office of Technology Transfer at US Naval Research Laboratory, Code 1004, Washington, DC 20375, USA; +1.202.767.7230; nrltechtran@us.navy.mil, referencing Navy Case Number 212527-US2.

### FIELD OF THE DISCLOSURE

This disclosure relates to antennas, including wideband antenna arrays.

### BACKGROUND

Planar printed antenna arrays can serve as the aperture portion of a phased array antenna system or sub-system. Conventional planar printed arrays can be directly interfaced with coaxial connectors and cables-coaxial connectors and cables being the most common interface type for radio frequency (RF) systems. However, they are not the best choice for interfacing with balanced/differential input/output systems. For example, some electronics, such as power amplifiers often used in transmit applications, have differential outputs. To interface this type of radiator with electronics having differential outputs, a “balun” must be used between the circuits to transform from a “balanced line to an unbalanced line.” Baluns add significant loss and become exceedingly bulky for wide bandwidths of operation. Conventional radiators can be more susceptible to noise, and they are generally not symmetric, which can increase undesired cross-polarization and orthogonal port coupling levels.

### BRIEF DESCRIPTION OF THE DRAWINGS/FIGURES

The accompanying drawings, which are incorporated in and constitute part of the specification, illustrate embodiments of the disclosure and, together with the general description given above and the detailed descriptions of embodiments given below, serve to explain the principles of the present disclosure. In the drawings:

FIG. 1 is a diagram of an exemplary planar printed wideband antenna radiator, where a cross-section side view (x-z) of the radiator profile is shown;

FIG. 2 is a top view of an exemplary planar printed wideband dual-polarized antenna radiator;

FIG. 3 is an isometric view of an exemplary planar printed wideband dual-polarized antenna radiator;

FIG. 4 is a diagram showing a cross-sectional view of two side-by-side units of an exemplary BI-PPA array radiator in accordance with an embodiment of the present disclosure;

FIG. 5 is a diagram showing a cross-sectional view of two side-by-side units of an exemplary BI-PPA array radiator where common shielding pins are extended in accordance with an embodiment of the present disclosure;

FIG. 6 is a diagram showing a top view for a representative 3×3 section of an exemplary BI-PPA array radiator in accordance with an embodiment of the present disclosure;

FIG. 7 is a diagram showing a bottom view for a representative 3×3 section of an exemplary BI-PPA array radiator in accordance with an embodiment of the present disclosure;

FIG. 8 is a diagram showing an isometric view for a representative 3×3 section of an exemplary BI-PPA array radiator in accordance with an embodiment of the present disclosure;

FIG. 9 is a diagram showing a representative section of an embodiment of a BI-PPA realized by inserting a second polarization of radiators (and associated functional structures) orthogonal to the first in accordance with an embodiment of the present disclosure;

FIG. 10 is a diagram showing a bottom view of the representative section of FIG. 9 in accordance with an embodiment of the present disclosure;

FIG. 11 is a diagram showing an isometric view of the representative section of FIG. 9 in accordance with an embodiment of the present disclosure;

FIG. 12 is a diagram showing simulated active Voltage Standing Wave Ratio (VSWR) for an infinite array of radiators in an embodiment with offset center radiator pairs first in accordance with an embodiment of the present disclosure;

FIG. 13 is a diagram showing reports for broadside realized gain simulations for an embedded array element in accordance with an embodiment of the present disclosure;

FIG. 14 is a diagram showing a representative section of an exemplary embodiment of the present disclosure that can be generated by inserting a second polarization of radiators (and associated functional structures) orthogonal to the first;

FIG. 15 is a diagram showing a bottom view of FIG. 15 in accordance with an embodiment of the present disclosure;

FIG. 16 is a diagram showing an isometric view of FIG. 14 in accordance with an embodiment of the present disclosure;

FIG. 17 is a diagram showing a simulated active Voltage Standing Wave Ratio (VSWR) for an infinite array of radiators in accordance with an embodiment of the present disclosure; and

FIG. 18 is a diagram showing broadside realized gain simulations for an infinite array of radiators in accordance with an embodiment of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

In the following description, numerous specific details are set forth to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to understand that such description(s) can affect such feature, structure, or characteristic in connection with other embodiments whether or not explicitly described.

### 1. Overview

Embodiments of the present disclosure provide systems and methods for planar-printed antenna arrays that have balanced inputs (e.g., excitation pairs) that can directly mate with differential outputs on system electronics. The apertures can be produced with solder/signal pads in lieu of commercial connectors for pick-and-place, no touch labor integration of antenna apertures with panel electronics using Ball Grid Array (BGA) technology.

Embodiments of the present disclosure include both single-polarization and dual-polarization radiators that can be coupled at the radiator ends to increase operational bandwidth. Embodiments of the present disclosure provide improvements over apertures that have been designed and fielded in the past which have single ended coaxial feeds on the antennas. Single-ended coaxial feeds are suitable for many applications, but often associated electronics to which apertures are integrated with feature a differential outputs. In this case, a balanced input aperture is beneficial. Further, for integration with planar electronics, it can be beneficial to achieve planar integration of the aperture without using extra/expensive connectors, hence the built-in Ball Grid Array (BGA) interface capability. Because the radiators have balanced inputs and are wideband, planar-printed antenna modules in accordance with embodiments of the present disclosure can be tiled as BGA packages. For short, a family of radiators in accordance with embodiments of the present disclosure can be referred to as Balanced-Input Planar-Printed Antenna (BI-PPA) Arrays as Coupled Wideband Modular Packages.

### 2. Exemplary Planar Printed Wideband Antenna Radiator

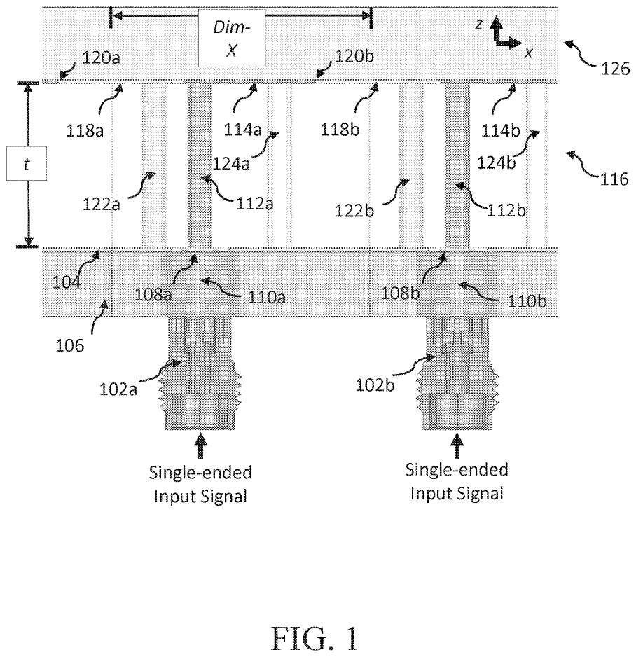

FIG. 1 is a diagram of an exemplary planar printed wideband antenna radiator, where a cross-section side view (x-z) of the radiator profile is shown. The antennas radiate primarily in the z direction, and repeat at a regular lattice spacing in x. Two repetitions of the array unit cell of an interval 405 (e.g., dim-X) are depicted. Without loss of generality, a single polarization is shown, though a second polarization could be inserted orthogonal to the single polarization (repeating in the y-direction).

In FIG. 1, an unbalanced input signal is applied to the antenna through an input port. More generally, an array of unbalanced input signals can be applied to an array of antennas through an array of input ports. These input ports can take the form of a commercial off the shelf (COTS) connector as depicted by connectors 102 (e.g., unbalanced coaxial cable(s)). The antennas have a mutual ground 104, which can be optionally reinforced with a thicker conductive backing 106.

In FIG. 1, the outer conductor of the coaxial connector is either fastened or soldered to mutual ground 104/conductive backing 106. In FIG. 1, the center conductors of connectors 102 connect to signal pads 108 with electrical interconnects 110. Interconnects 110 can be solders, fuzz buttons, pogo pins, or similar electrical contact mechanisms without loss of generality. Signal pads 108 can be connected to plated through vias 112, which connect to the signal arms 114 of the radiators. Signal arms 114 are printed on top of the printed material layers 116 of thickness t, the thickness and number of layers 116 being a tuning parameter.

In FIG. 1, signal arms 114 are paired with grounded arms 118 that can be of similar (but often not identical) size and shape. Signal arms 114 and ground arms 118 can be connected at end points 120, or they can be coupled with a capacitive gap that can be used for tuning and to control the lower frequency of operation f_{low} for the array radiators. In FIG. 1, the grounded arm is connected to the mutual ground 104 with plated through ground vias 122. Generally speaking, for this radiator topology some form of common mode suppression can be used. This can be accomplished by additional common mode vias 124 which can be shorted to the signal arm, shorted to the ground arm, capacitively coupled to either arm, or in some combination of these embodiments. Though not necessary, matching layers 126 can be added on top of the radiating structure to improve wide (scan) angle impedance matching of the array.

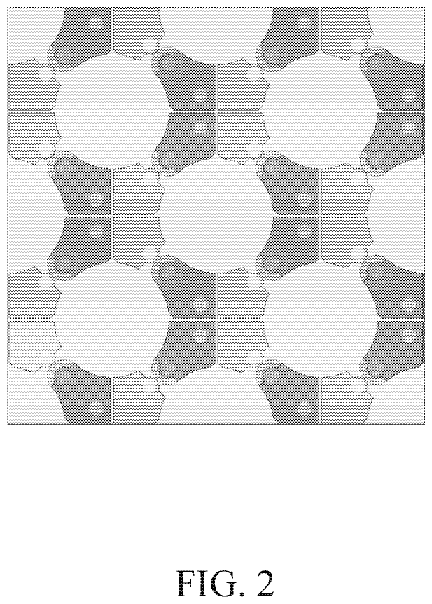

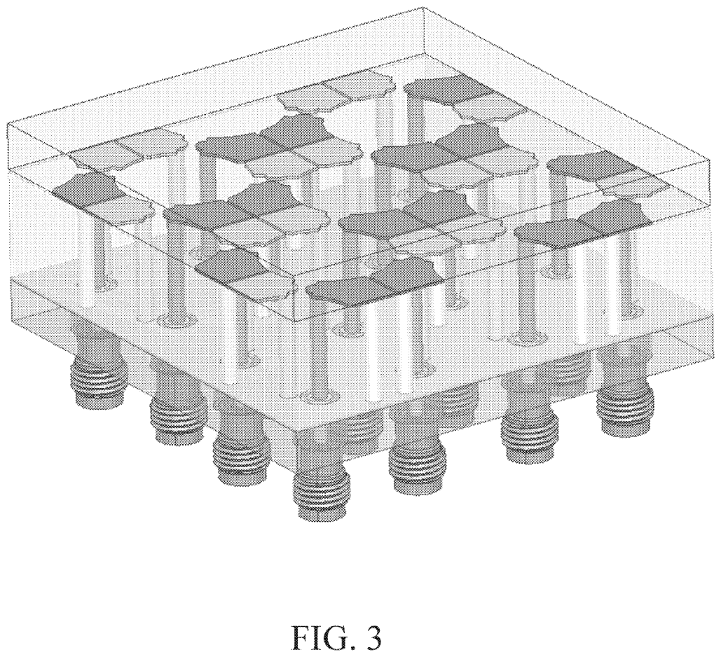

FIG. 2 is a top view of an exemplary planar printed wideband dual-polarized antenna radiator. FIG. 3 is an isometric view of an exemplary planar printed wideband dual-polarized antenna radiator.

### 3. Exemplary BI-PPA Arrays

Exemplary embodiments of a Balanced-Input, Planar-Printed Antenna (BI-PPA) Array in accordance with embodiments of the present disclosure will now be described. The BI-PPA can be produced as wideband coupled modules that can be tiled side-by-side as BGA packages. The radiator arrays can have multiple planes of symmetry, allowing for multiple embodiments to match alternative channel layouts (offset or co-incident), as described below.

### 3.1. Exemplary BI-PPA Embodiment

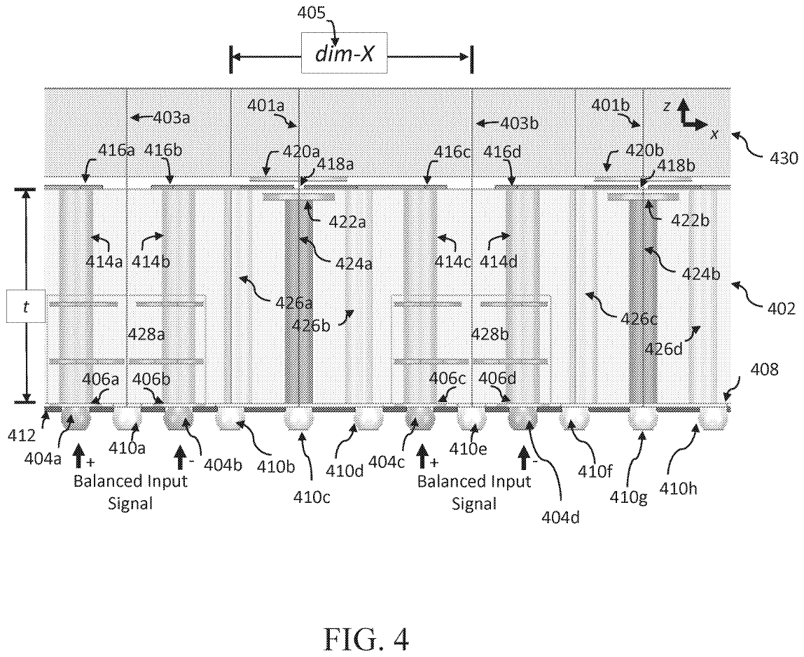

FIG. 4 is a diagram showing a cross-sectional view of two side-by-side units of an exemplary BI-PPA array radiator in accordance with an embodiment of the present disclosure. FIG. 4 shows a first symmetry plane 401 and a second symmetry plane 403. An exemplary interval 405 is labeled as dim-X in FIG. 4. In FIG. 4, the radiators include planar-printed circuits on one or more layers of planar printed materials 402. The component will be described in a transmit mode of operation. A balanced input signal can be applied to the radiators through a pair of signal interconnects 404. The interconnects 404 can be BGA solder balls, another form of solder, pogo pins, fuzz buttons, conductive wires, etc. In an embodiment, each radiator has a pair of balanced signal pads 406 to which the balanced signal can be applied. In an embodiment, there is a mutual ground 408 for the array structure. Ground 408 can be connected to the feed electronics with shielding interconnects 410, represented most generally as solder balls. For example, with a coaxial cable, one terminal is larger than an other, and so the signal is unbalanced. In an embodiment, the balanced signal uses two (or more) signal feeds that are equal in size and symmetric, and the fields formed by the signal feeds and the signals passing through them are symmetric, equal, and balanced.

In an embodiment that can be produced with solder balls for BGA attachment, there can be a solder mask layer 412 applied to the ground 408 as an automation guide to where the solder must be applied. In an embodiment, mirrored plated through vias connect to the serve as balanced signal vias 414 (e.g., in pairs). In an embodiment, the balanced signal vias 414 are connected from the balanced signal pads 406 to balanced pairs of printed radiators 416. In an embodiment, radiators 416 can be coupled at the end points with respective capacitive gaps 418 for bandwidth tuning. In an embodiment, additional bandwidth tuning can be achieved by introducing respective upper coupling plates 420, and/or respective lower coupling plates 422. The size of plates 420 and 422, and the separation from radiators 416 can be used as tuning parameters.

In an embodiment, respective common shielding pins 424 can be introduced for both shielding and also for suppression of undesired standing wave modes, i.e. common modes. However, introducing pins 424 can itself introduce other undesired modes, but this can be avoided if pins 424 are connected to plates 422. Undesired common modes can also be disrupted by introducing balanced shielding vias 426. Vias 426 can be connected to solder mask layer 412 and/or radiators 416, or capacitively coupled to solder mask layer 312 and/or radiators 416.

In an embodiment, the spacing of the balanced signal vias 414 can be largely dictated by the placement of the signal interconnects 404 and may not be suitable for wideband to ultra-wideband operational frequency ranges of the radiating structure. As such, respective inline balanced printed stepped impedance transformers 428 can be introduced after the balanced signal pads 406. In an embodiment, printed stepped impedance transformers 428 can be planar printed in that they can be etched from copper foil. In an embodiment, inclusion of balanced printed stepped impedance transformers 428 is a unique feature of the BI-PPA that makes additional interposer circuit layers for dilation of the signals unnecessary. Impedance matching, particularly for wide angle scanning, can also be improved by adding a wide angle impedance matching layer 430.

In an embodiment, the impedance at signal pads 406 is a first value (e.g., 50 ohms or 100 ohm pairs), and the impedance at radiators 416 is a second value (e.g., 377 ohms), and impedance transformers 428 ease the transition (e.g., in “steps”) from the first value to the second value. In an embodiment, the impedance transition from signal pads 406 to radiators 416 can be controlled by configuring stepped impedance transformers 428. For example, the gap between each transformer in a transformer pair in stepped impedance transformers 428 can be adjusted by a predetermined amount, and the separation between each pair of transformers in stepped impedance transformers 428 can be adjusted by a predetermined amount. In an embodiment the total height in stepped impedance transformers 428 (e.g., the total height of the transformer section) can be adjusted by a predetermined amount for impedance matching. In an embodiment, stepped impedance transformers 428 are positioned closer to signal pads 406 than radiators 416. In an embodiment, the total height of stepped impedance transformers 428 is less than half of the height signal pads 406 to radiators 416.

In an embodiment, two or more impedance transformers are used to form stepped impedance transformers 428. In an embodiment, transformers in stepped impedance transformers 428 are formed from copper foil. In an embodiment, a first impedance transformer in impedance transformers 428 is coupled to a via (e.g., via 414a) at a lower position than a second impedance transformer in impedance transformers 428. In an embodiment, a second impedance transformer in impedance transformers 428 is smaller than a first impedance transformer in impedance transformers 428 (e.g., by having a smaller length, width, circumference, etc.). In an embodiment, a gap between a second impedance transformer pair in impedance transformers 428 is smaller than a gap between a first impedance transformer pair in impedance transformers 428. In an embodiment, all transformers in impedance transformers 428 are structurally equivalent. In an embodiment, via 414b is parallel to via 414a, and via 414b has stepped impedance transformers (in impedance transformers 428a) coupled to via 414b that are parallel to (and equal in respective size to) stepped impedance transformers (in impedance transformers 428a) that are coupled to via 414a. In an embodiment, each transformer coupled to via 414a that is parallel to a respective transformer coupled to via 414b forms a transformer pair with that respective transformer.

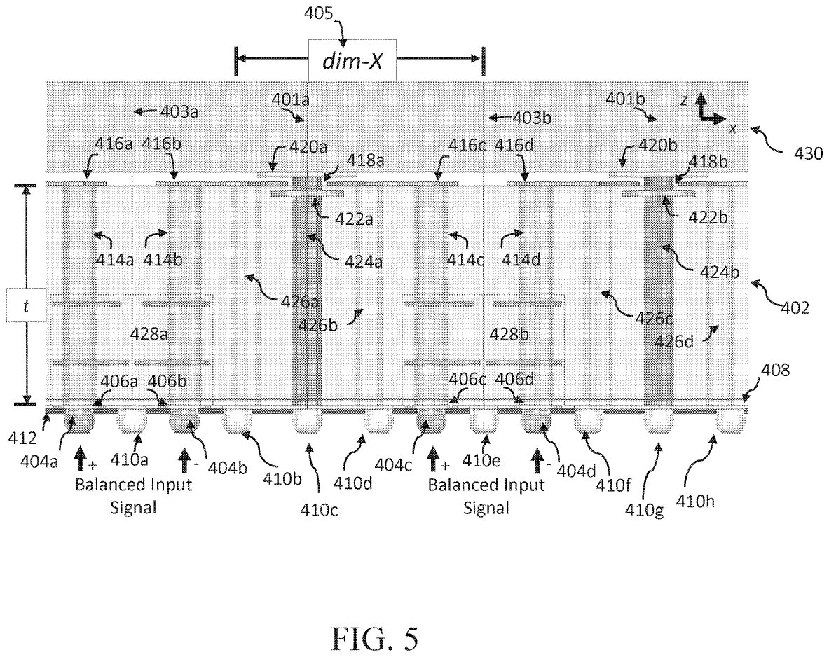

FIG. 5 is a diagram showing a cross-sectional view of two side-by-side units of an exemplary BI-PPA array radiator where common shielding pins are extended in accordance with an embodiment of the present disclosure. For a case where plates 420 are connected to shielding pins 424, shielding pins 424 can be extended as shown in FIG. 5. In this case, radiators 416 can be trimmed to avoid electrical contact with shielding pins 424.

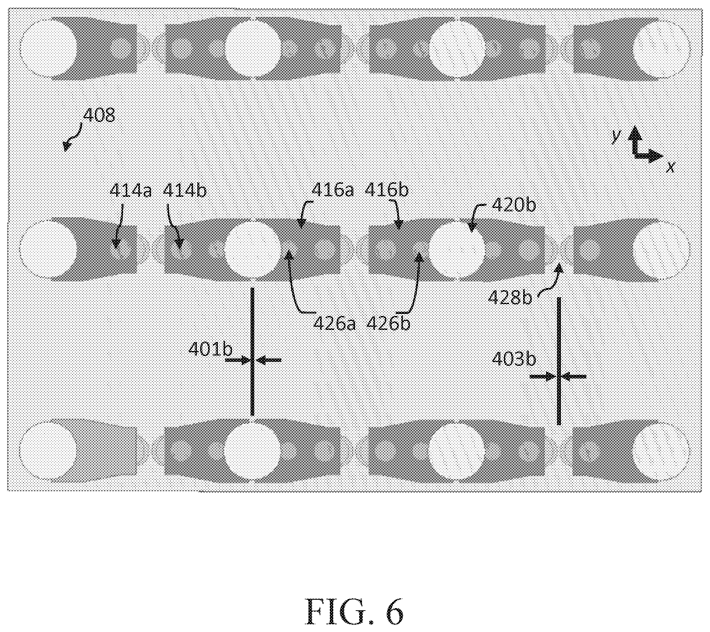

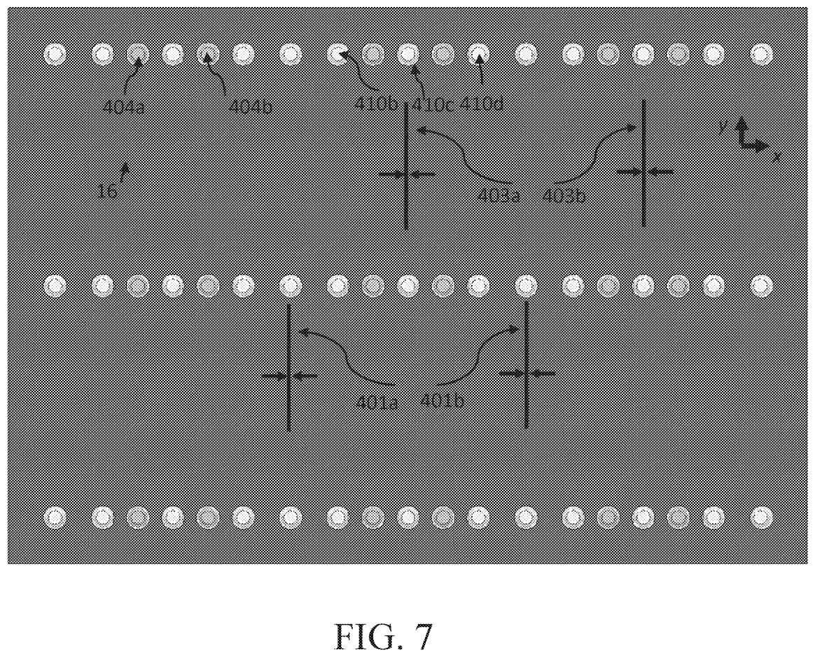

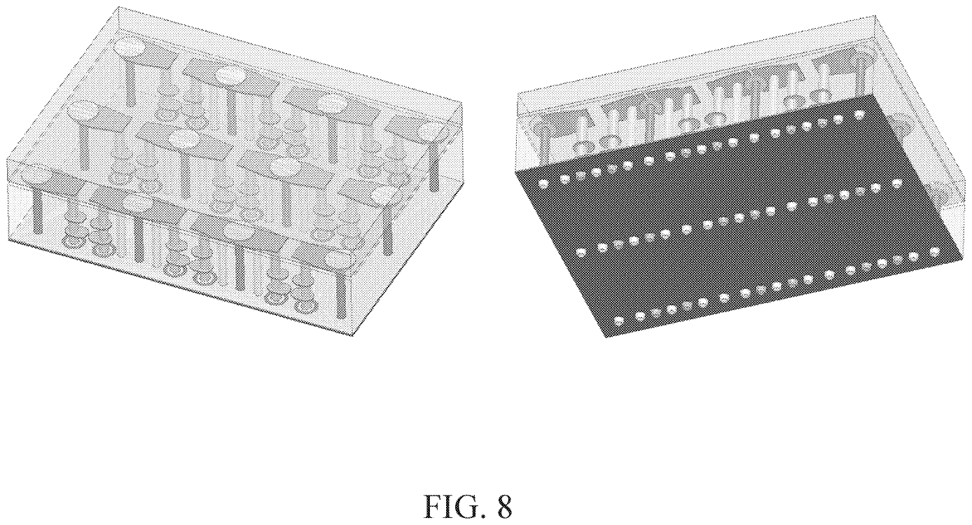

FIG. 6 is a diagram showing a top view for a representative 3×3 section of an exemplary BI-PPA array radiator in accordance with an embodiment of the present disclosure. FIG. 7 is a diagram showing a bottom view for a representative 3×3 section of an exemplary BI-PPA array radiator in accordance with an embodiment of the present disclosure. FIG. 8 is a diagram showing an isometric view for a representative 3×3 section of an exemplary BI-PPA array radiator in accordance with an embodiment of the present disclosure.

FIGS. 4-6 show exemplary BI-PPA embodiments depicting a case where all array radiators are of the same (single) polarization. Because of inherent mirror symmetry in the BI-PPA design, additional embodiments of the BI-PPA can be derived by inserting a second polarization of radiators (and associated functional structures)—orthogonal to the first—at key symmetry planes. Inserting a second polarization of radiators (and associated functional structures) orthogonal to the first at symmetry plane 401 creates an embodiment of the BI-PPA having an offset-phase-center implementation of a dual-polarized phased array. This insertion can be done at intervals equal to interval 405 (e.g., dim-X). Alternatively, inserting a second polarization of radiators (and associated functional structures) orthogonal to the first at symmetry plane 403 creates a further embodiment of the BI-PPA, a coincident-phase-center implementation of a dual-polarized phased array. In an embodiment, this insertion can also be done at intervals equal to dim-X.

### 3.2. Exemplary BI-PPA Embodiment With Offset Center Radiator Pairs

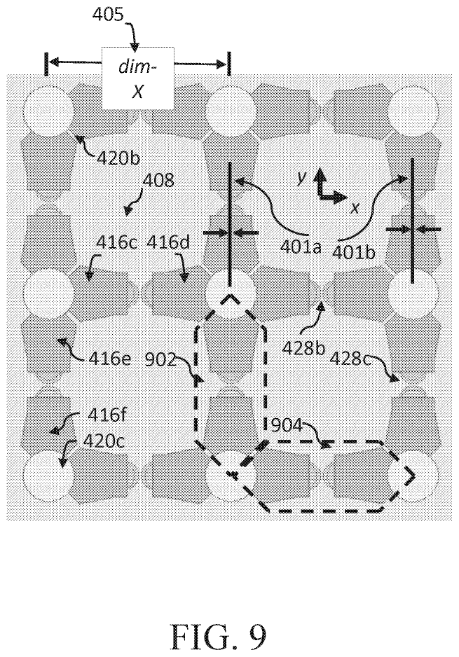

FIG. 9 is a diagram showing a representative section of an embodiment of a BI-PPA realized by inserting a second polarization of radiators (and associated functional structures) orthogonal to the first in accordance with an embodiment of the present disclosure. In FIG. 9, a second polarization of radiators are inserted at symmetry plane 401. In FIG. 9, features are similar as those outlined in FIGS. 4-6 but with second set of structures inserted orthogonal to the fist at 401, leading to geometric modifications to maintain symmetry. In an embodiment, printed radiators 416 are still coupled at capacitive gaps 418. In FIG. 9, printed radiators 416 are in orthogonal pairs as depicted in FIG. 9, where a vertical radiator 902 is outlined, adjacent and orthogonal to a horizontal radiator 904. In an embodiment, each radiator in an orthogonal pair does not interfere with the other radiator in the orthogonal pair, and each functions independently. When combined in space, vertical radiator 902 and horizontal radiator 904 can be used to configure polarization. For example, in an embodiment, for horizontal polarization, horizontal radiator 904 can be turned on, and vertical radiator 902 can be turned off. In an embodiment, for vertical polarization, horizontal radiator 904 can be turned off, and vertical radiator 902 can be turned on. In an embodiment, for circular polarization, horizontal radiator 904 can be turned on, and vertical radiator 902 can be turned on (e.g., with proper phasing such that horizontal radiator 904 and vertical radiator 902 are 904 degrees out of phase with respect to each other).

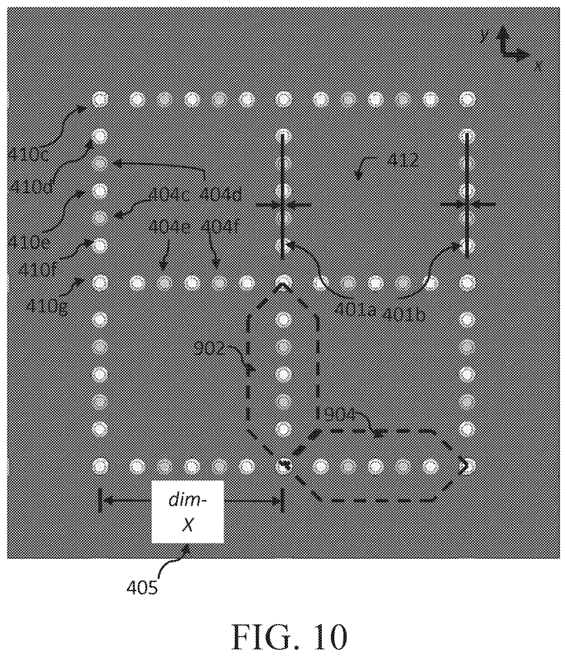

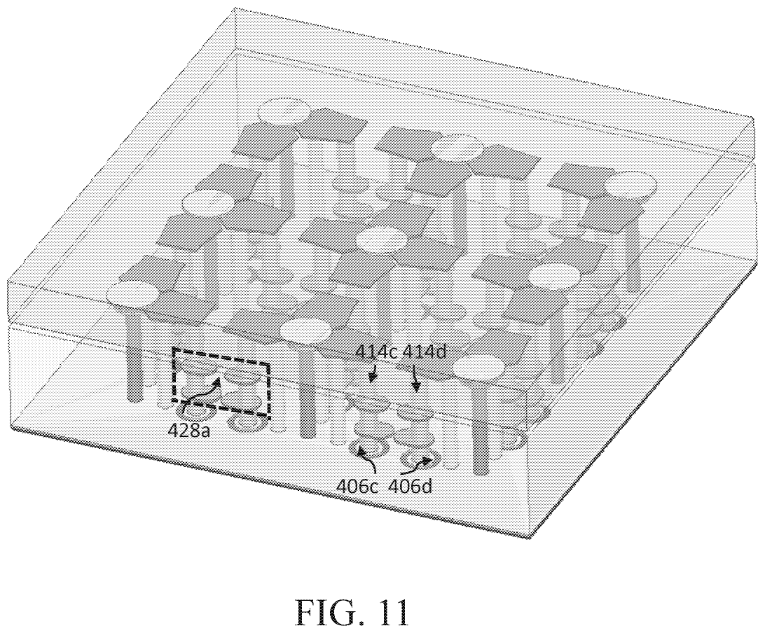

In FIG. 9, the physical centers of vertical radiator 902 and horizontal radiator 904 are offset in space. FIG. 10 is a diagram showing a bottom view of the representative section of FIG. 9 in accordance with an embodiment of the present disclosure. In FIG. 10, outlines of vertical radiator 902 and horizontal radiator 904 are indicated in the diagram. Note that the layout for electrical interconnects are symmetric in this view. Signal inputs at interconnects 404 are symmetric with respect shielding features 410. FIG. 11 is a diagram showing an isometric view of the representative section of FIG. 9 in accordance with an embodiment of the present disclosure. In FIG. 11, impedance transformers 428 provide an inline transform feature, and it is possible to space balanced signal vias 414 and balanced signal pads 406 at a spacing used to satisfy either printed circuit board manufacturing limitations or placement for connecting to the electronics circuits.

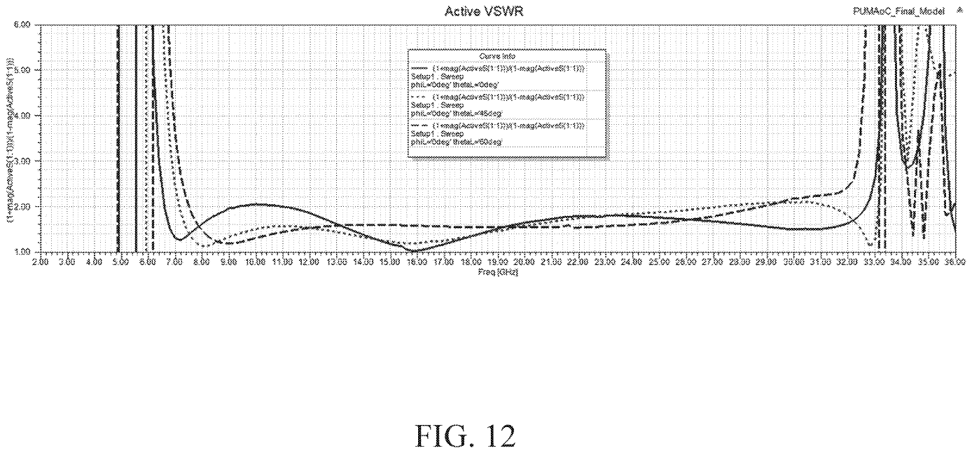

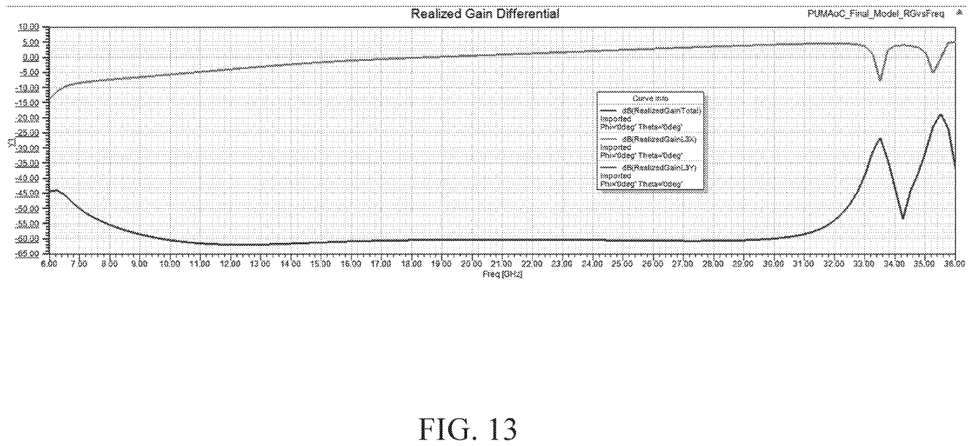

FIG. 12 is a diagram showing simulated active Voltage Standing Wave Ratio (VSWR) for an infinite array of radiators in an embodiment with offset center radiator pairs first in accordance with an embodiment of the present disclosure. For FIG. 12, the array was tuned to operate over the frequency range of 7.5 GHz to 32 GHz, maintaining VSWR well below 3.0 for broadside, 45-degree, and 60-degree scans. FIG. 13 is a diagram showing reports for broadside realized gain simulations for an embedded array element in accordance with an embodiment of the present disclosure. In an embodiment, low-end frequency cutoff can be well below 7.5 GHz, and the first undesired (non-radiating) modes do not occur until 33.5 GHz.

### 3.3. Exemplary BI-PPA Embodiment With a Coincident-Phase-Center

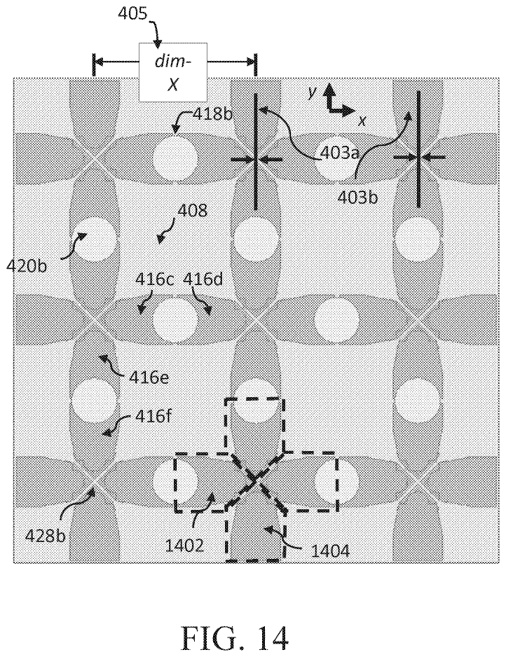

FIG. 14 is a diagram showing a representative section of an exemplary embodiment of the present disclosure that can be generated by inserting a second polarization of radiators (and associated functional structures) orthogonal to the first. In FIG. 14, a second polarization of radiators (and associated functional structures) orthogonal to the first are inserted at symmetry plane 403. In FIG. 14, features are similar as those outlined in FIG. 4 with geometry trimmed and tuned to maintain symmetry and electromagnetic function. In FIG. 14, printed radiators 416 are still coupled at capacitive gaps 418. In FIG. 14, the printed radiators 416 are in orthogonal pairs that have a coincident physical center. In FIG. 14, a vertical radiator 1402 is outlined, coincident and orthogonal to a horizontal radiator 1404.

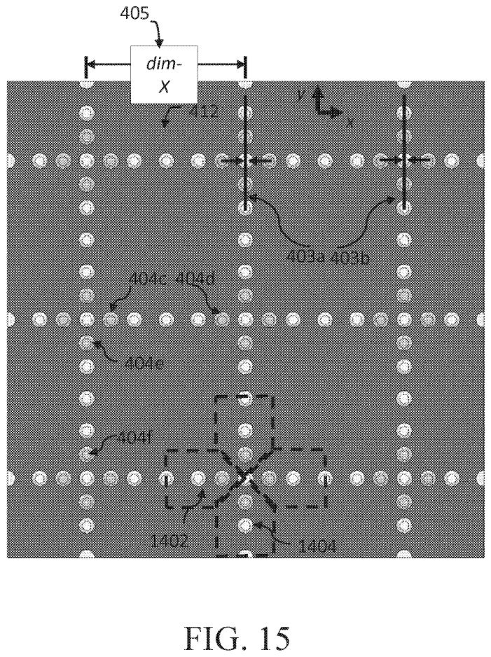

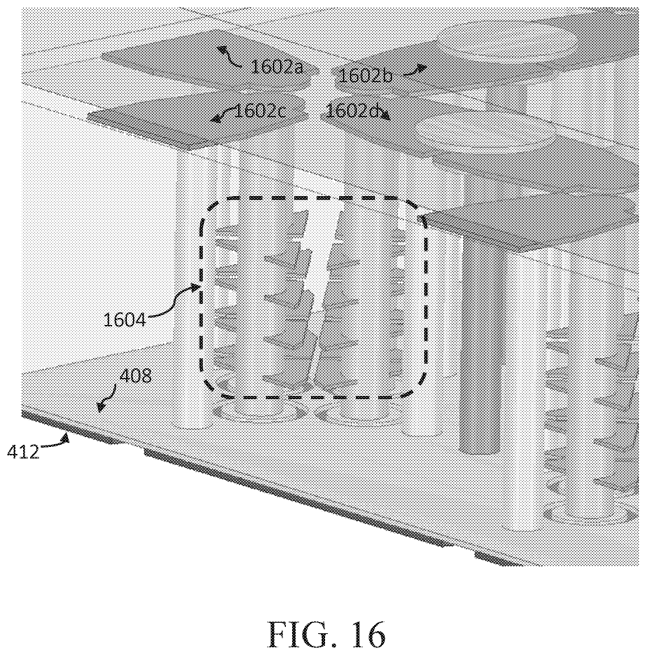

FIG. 15 is a diagram showing a bottom view of FIG. 15 in accordance with an embodiment of the present disclosure. FIG. 15 shows a symmetric and regular layout of BGA signal pads and BGA balls conforming to interval 405. Outlines of vertical radiator 1402 and horizontal radiator 1404 are included for placement, though the radiating structures are not visible as they are hidden behind ground 408 and solder mask layer 412. FIG. 16 is a diagram showing an isometric view of FIG. 14 in accordance with an embodiment of the present disclosure. FIG. 16 shows printed radiators printed radiators 1602 similar to printed radiators printed radiators 416 in FIG. 4. FIG. 16 shows impedance transformers 1604 similar to impedance transformers 428 in FIG. 4.

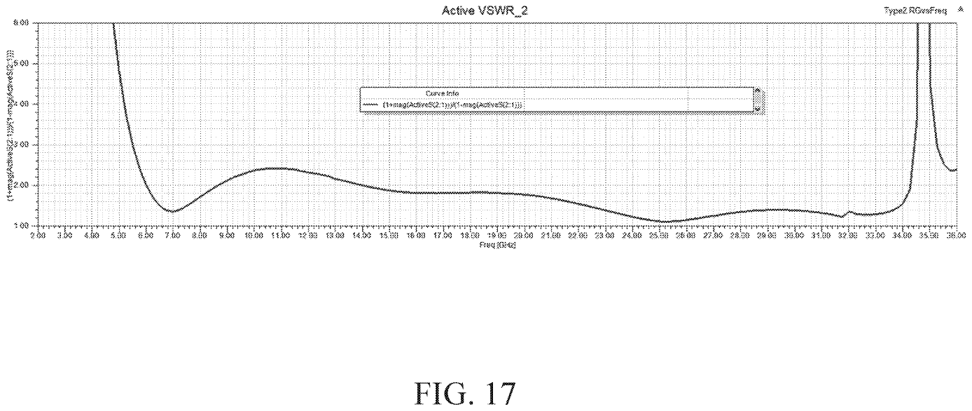

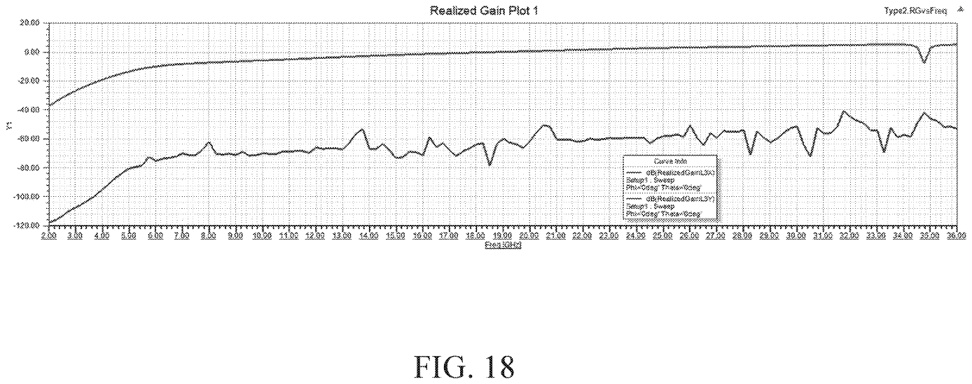

FIG. 17 is a diagram showing a simulated active Voltage Standing Wave Ratio (VSWR) for an infinite array of radiators in accordance with an embodiment of the present disclosure. In FIG. 17, the upper frequency limit f_{high} is 32 GHz, as dictated by interval 405 for active scans without inducing grating lobes in visible space, and the array is tuned to operate down to roughly 6 GHz or lower. FIG. 18 is a diagram showing broadside realized gain simulations for an infinite array of radiators in accordance with an embodiment of the present disclosure. In FIG. 18, low-end frequency cutoff is well below 6 GHz, and the first undesired (non-radiating) modes do not occur until 34.5 GHz.

### 4. Exemplary Advantages

Conventional systems do not support a balanced input. Embodiments of the present disclosure including balanced input planar printed antennas have several advantages. For example, the balanced inputs of the BI-PPA allow for geometric symmetry. This geometric symmetry results in field symmetry within the structure, which results in greater scan symmetry, better isolation between orthogonal port channels of the array system, and also improved cross-polarization performance.

Another advantage of the balanced input of the BI-PPA is that it can interface more directly with array electronics that have a native differential output. It is not necessary to use expensive and unbalanced commercial connectors to interface BI-PPA array apertures with electronics panels. Nor is it required to implement baluns between differential output electronics and single-ended array radiators. Baluns are components or devices that transform a balanced signal to an unbalanced signal, and most often introduce additional losses 1 dB or greater. The greater the operational frequency range of the radiator and electronics, the greater the size of the balun required and also the expense. Not requiring a balun between electronics and radiator aperture is a considerable advantage.

Another advantage of the BI-PPA is the fact that the construction and layout can lend itself to implementation as BGA packages. The BI-PPA is a cost-effective planar-printed antenna array aperture that can be produced with balanced input signal pads, isolated with industry-standard solder mask applications to printed circuit boards. Thus, the BI-PPA can be produced in customer-selected module sizes with BGA interfaces on the back, allowing for pick-and-place automated assembly of the aperture devices.

The BI-PPA can be implemented as radiator pairs that have a center either physically offset or physically coincident. The physically-offset orthogonal element pairs have a unique geometry. The coincident orthogonal element pairs have a unique geometry.

Often, balanced inputs are not compatible with printed antenna structures because there are physical limitations on how close two input signals-physically implemented with plated through vias-can be placed to each other. Most often, the inputs for printed aperture layers will be produced to within manufacturing requirements, and then additional circuit layers-similar in principle to baluns-are used to transform the signals from the antenna aperture to the electronics. These additional circuit layers are normally called dilation layers or interposers, and contribute additional loss, volume, and expense to a system. The BI-PPA has a unique inline balanced printed stepped impedance transformer that can perform the same function as an embedded inline structure that is part of the same printed circuit board production process at no additional cost or complexity.

The BI-PPA can be implemented with a number of bandwidth-enhancing features, including 0 or more upper coupling plates and/or 0 or more lower coupling plates. The balanced-input geometry is also compatible was various implementations for common mode mitigation structures such as the common shielding pin or balanced shielding vias. Common mode mitigation structures can be implemented with capacitive coupling or electrical contact to printed radiators and coupling plates.

### 5. Conclusion

It is to be appreciated that the Detailed Description, and not the Abstract, is intended to be used to interpret the claims. The Abstract may set forth one or more but not all exemplary embodiments of the present disclosure as contemplated by the inventor(s), and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments.

What is claimed is:

1. An antenna, comprising:
a first via coupled to a first signal interconnect;
a first planar printed impedance transformer coupled to the first via at a first position;
a second planar printed impedance transformer coupled to the first via at a second position, wherein the second position is higher than the first position; and
a first radiator coupled to the first via.

2. The antenna of claim 1, further comprising:
a second via coupled to a second signal interconnect;
a third planar printed impedance transformer coupled to the second via at a third position;
a fourth planar printed impedance transformer coupled to the second via at a fourth position, wherein the fourth position is higher than the third position, wherein the third planar printed impedance transformer has an equal size to the first planar printed impedance transformer, wherein the fourth planar printed impedance transformer has an equal size to the second planar printed impedance transformer, wherein the first planar printed impedance transformer is parallel to the third planar printed impedance transformer, and wherein the second planar printed impedance transformer is parallel to the fourth planar printed impedance transformer; and
a second radiator coupled to the first via.

3. The antenna of claim 2, further comprising:
a shielding via coupled to the second radiator and to a first shielding interconnect.

4. The antenna of claim 3, further comprising:
a pin coupled to a second shielding interconnect and to a first coupling plate.

5. The antenna of claim 4, wherein the first coupling plate is positioned below the second radiator, wherein a second coupling plate is positioned above the second radiator, and wherein the first coupling plate is capacitively coupled to the second coupling plate.

6. The antenna of claim 4, wherein the first coupling plate is positioned below the second radiator, wherein a second coupling plate is positioned above the second radiator, and wherein the first coupling plate and the second coupling plate are coupled to the first via.

7. The antenna of claim 2, further comprising:
a first signal pad coupled to the first signal interconnect and the first via; and
a second signal pad coupled to the second signal interconnect and the second via, wherein the first signal pad and the second signal pad are configured to receive a balanced signal.

8. An antenna, comprising:
a first radiator, comprising:
a first via coupled to a first signal interconnect,
a first planar printed impedance transformer coupled to the first via at a first position,
a second planar printed impedance transformer coupled to the first via at a second position, wherein the second position is higher than the first position, and
a first printed radiator coupled to the first via; and
a second radiator, wherein the second radiator is orthogonal to the first radiator.

9. The antenna of claim 8, further comprising:
a second via coupled to a second signal interconnect;
a third planar printed impedance transformer coupled to the second via at a third position;
a fourth planar printed impedance transformer coupled to the second via at a fourth position, wherein the fourth position is higher than the third position, wherein the third planar printed impedance transformer has an equal size to the first planar printed impedance transformer, wherein the fourth planar printed impedance transformer has an equal size to the second planar printed impedance transformer, wherein the first planar printed impedance transformer is parallel to the third planar printed impedance transformer, and wherein the second planar printed impedance transformer is parallel to the fourth planar printed impedance transformer; and
a second printed radiator coupled to the first via.

10. The antenna of claim 9, further comprising:
a shielding via coupled to the second printed radiator and to a first shielding interconnect; and
a pin coupled to a second shielding interconnect and to a first coupling plate.

11. The antenna of claim 10, wherein the first coupling plate is positioned below the second printed radiator, and wherein a second coupling plate is positioned above the second printed radiator.

12. The antenna of claim 11, wherein the first coupling plate is capacitively coupled to the second coupling plate.

13. The antenna of claim 11, wherein the first coupling plate and the second coupling plate are coupled to the first via.

14. The antenna of claim 11, wherein the first radiator and the second radiator are coupled to the first coupling plate and the second coupling plate.

15. The antenna of claim 14, wherein the second radiator comprises:
a third printed radiator positioned above the first coupling plate and below the second coupling plate.

16. The antenna of claim 9, further comprising:
a first signal pad coupled to the first signal interconnect and the first via; and
a second signal pad coupled to the second signal interconnect and the second via, wherein the first signal pad and the second signal pad are configured to receive a balanced signal.

17. An antenna, comprising:
a first radiator, comprising:
a first via coupled to a first signal interconnect,
a first planar printed impedance transformer coupled to the first via at a first position,
a second planar printed impedance transformer coupled to the first via at a second position, wherein the second position is higher than the first position, and
a first printed radiator coupled to the first via; and
a second radiator, wherein the second radiator is orthogonal to the first radiator, and wherein the first radiator and the second radiator have a coincident physical center.

18. The antenna of claim 17, further comprising:
a second via coupled to a second signal interconnect;
a third planar printed impedance transformer coupled to the second via at a third position;
a fourth planar printed impedance transformer coupled to the second via at a fourth position, wherein the fourth position is higher than the third position, wherein the third planar printed impedance transformer has an equal size to the first planar printed impedance transformer, wherein the fourth planar printed impedance transformer has an equal size to the second planar printed impedance transformer, wherein the first planar printed impedance transformer is parallel to the third planar printed impedance transformer, and wherein the second planar printed impedance transformer is parallel to the fourth planar printed impedance transformer; and
a second printed radiator coupled to the first via.

19. The antenna of claim 18, further comprising:
a shielding via coupled to the second printed radiator and to a first shielding interconnect;
a pin coupled to a second shielding interconnect and to a first coupling plate, wherein the first coupling plate is positioned below the second printed radiator, wherein a second coupling plate is positioned above the second printed radiator, and wherein the first radiator and the second radiator are coupled to the first coupling plate and the second coupling plate.

20. The antenna of claim 17, further comprising:
a third planar printed impedance transformer coupled to the first via at a third position; and
a fourth planar printed impedance transformer coupled to the first via at a fourth position.
